(19) United States
(12) Patent Application Publication
(10) Pub. No.: US 2018/0336485 A1
(43) Pub. Date: Nov. 22, 2018

(54) INTELLIGENT TICKET ASSIGNMENT THROUGH SELF-CATEGORIZING THE PROBLEMS AND SELF-RATING THE ANALYSTS

(71) Applicant: Dell Products L.P., Round Rock, TX (US)

(72) Inventors: Sathish Kumar Bikumala, Round Rock, TX (US); Pat Quigley, Austin, TX (US); Hung The Dinh, Austin, TX (US)

(21) Appl. No.: 15/596,453

(22) Filed: May 16, 2017

(51) Int. Cl. G06N 99/00; G06F 17/30; G06Q 10/06; G06N 5/02

(52) U.S. Cl. CPC G06N 99/005; G06F 17/3053; G06N 5/022; G06Q 10/06398; G06F 17/30598

(57) ABSTRACT

Systems and methods for intelligent ticket assignment through self-categorizing the problems and self-rating the analysts may include a client information handling system and a ticketing information handling system that may have a ticketing processor subsystem. The ticketing processor subsystem may receive a problem ticket that may include a problem and associated problem information from the client information handling system. The ticketing processor subsystem may also categorize the problem into a problem category of a learned problem profile. The ticketing processor subsystem may also perform a rank ordering algorithm to order learned analyst profiles of analysts that may have resolved one or more of the learned problems associated with the learned problem profile. The ticketing processor subsystem may also assign one of the analysts of the rank ordered learned analyst profiles to the problem ticket.

### BACKGROUND

### Field of the Disclosure

This disclosure relates generally to information handling systems and, more particularly, to an intelligent ticket assignment through self-categorizing the problems and self-rating the analysts for an information handling system.

### Description of the Related Art

As the value and use of information continues to increase, individuals and businesses seek additional ways to process and store information. One option available to users is information handling systems. An information handling system generally processes, compiles, stores, and communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may be utilized to execute user applications. When a problem occurs during execution of a user application, a user may request help from customer support to resolve the problem. Typically, the user submits the problem to customer support and the problem gets assigned to the first analyst of a customer support team who becomes available. The amount of time to resolve a given problem depends on the analyst assigned and their level of expertise to solve the given problem. If the first analyst is unable to resolve the problem, another analyst may need to be re-assigned to the problem.

### SUMMARY

In one aspect, a disclosed ticketing system may include a client information handling system, and a ticketing information handling system that may be coupled to the client information handling system, a learned problem profile database, and a learned analyst profile database. The ticketing information handling system may also include a ticketing processor subsystem that may be configured to receive a problem ticket that may include a problem and associated problem information from the client information handling system. The ticketing processor subsystem may also be configured to categorize the problem of the problem ticket into a problem category of a learned problem profile of the learned problem profile database by using a categorization algorithm that may identify a match between the problem and the associated problem information and learned problems and associated learned problem information of the learned problem profile. The ticketing processor subsystem may further be configured to perform a rank ordering algorithm to order learned analyst profiles of the learned analyst profile database that may be based on performance metrics associated with the learned problem profile and a respective analyst of each of the learned analyst profiles. The respective analyst of each of the learned analyst profiles may have resolved one or more of the learned problems associated with the learned problem profile. The ticketing processor subsystem may also be configured to assign one of the analysts of the rank ordered learned analyst profiles to the problem ticket by using an assignment algorithm that may be based on analyst information associated with the respective analyst of each of the rank ordered learned analyst profiles.

In any of the disclosed embodiments of the ticketing system, the ticketing processor subsystem may also be configured to add the problem ticket to the learned problem profile, when the categorization algorithm may identify the match between the problem and the associated problem information and the learned problems and the associated learned problem information. The ticketing processor subsystem may also be configured to add the problem ticket that may include the problem and the associated problem information to a new learned problem profile that may have a new problem category to the learned problem profile database, when the categorization algorithm may be unable to identify the match.

In any of the disclosed embodiments of the ticketing system, the ticketing processor subsystem may also be configured to, for each of one or more completed problem tickets in an operational database, retrieve an assigned analyst, analyst information that may be associated with the assigned analyst, a known learned problem profile in the learned problem profile database that may be associated with the completed problem ticket, and performance metrics that may be associated with the assigned analyst and the completed problem ticket from the operational database, and may add the analyst information and the performance metrics to a learned analyst profile in the learned analyst profile database that may be associated with the assigned analyst.

In any of the disclosed embodiments of the ticketing system, the ticketing processor subsystem may also be configured to search a knowledge database by using a knowledge matching algorithm that may identify a match between the problem and the associated problem information of the problem ticket and one or more matching knowledge articles for resolution of the problem of the problem ticket. The ticketing processor subsystem may further be configured to add the one or more matching knowledge articles for resolution of the problem to the problem ticket and the learned problem profile, prior to the assignment of one of the analysts of the rank ordered learned analyst profiles to the problem ticket. The one or more matching knowledge articles may include instructions for resolution of a completed problem ticket.

In any of the disclosed embodiments of the ticketing system, the ticketing processor subsystem may also be configured to create a problem ticket reference number for the problem ticket, add the problem ticket reference number to the problem ticket, and send the problem ticket reference number to the client information handling system.

In any of the disclosed embodiments of the ticketing system, the client information handling system may include a client processor subsystem that may be configured to detect an occurrence of the problem during execution of an application by the client processor subsystem. The client processor subsystem that may also be configured to, in response to the occurrence of the problem and a user request from a user interface, execute a ticket submission module that may collect the problem information associated with the occurrence of the problem, may create the problem ticket including the problem information, may send the problem ticket to the ticketing information handling system, may receive a problem ticket reference number that may be associated with the problem ticket from the ticketing information handling system, and may provide the problem ticket reference number to the user interface for user notification.

In any of the disclosed embodiments of the ticketing system, the categorization algorithm may be an anytime optimal search-based algorithm.

In any of the disclosed embodiments of the ticketing system, the problem information may include one or more of an error message, an error code, an exception code, a screenshot of information that may be displayed by a user interface on a display of the client information handling system, a page name and a page header of the information that may be displayed by the user interface on the display, a transaction name, a product name, a business process name, a business domain name, a problem severity, a submission time, a selected problem priority, an accepted problem priority, an adjusted SLA, an accepted SLA, and analyst email that may be associated with the problem of the problem ticket that may be associated with the problem information.

In any of the disclosed embodiments of the ticketing system, the performance metrics may include one or more of a customer satisfaction score, a service level agreement metric, and a reoccurrence metric.

In any of the disclosed embodiments of the ticketing system, the analyst information may include one or more of a business domain, shift information, a time zone, a holiday zone, a start date, a current work load, and a next available time.

In any of the disclosed embodiments of the ticketing system, the user information may include one or more of a business domain, shift information, a time zone, a holiday zone, contact information, analyst preferences, a next available time, and a SLA associated with a user.

In another aspect, a disclosed method may include, receiving, by a ticketing processor subsystem of a ticketing information handling system of a ticketing system, a problem ticket that may include a problem and associated problem information from a client information handling system of the ticketing system. The method may also include categorizing, by the ticketing processor subsystem, the problem of the problem ticket into a problem category of a learned problem profile of a learned problem profile database by using a categorization algorithm that may identify a match between the problem and the associated problem information and learned problems and associated learned problem information of the learned problem profile. The method may further include performing, by the ticketing processor subsystem, a rank ordering algorithm to order learned analyst profiles of a learned analyst profile database that may be based on performance metrics associated with the learned problem profile and a respective analyst of each of the learned analyst profiles. The respective analyst of each of the learned analyst profiles may have resolved one or more of the learned problems associated with the learned problem profile. The method may also include assigning, by the ticketing processor subsystem, one of the analysts of the rank ordered learned analyst profiles to the problem ticket by using an assignment algorithm based on analyst information associated with the respective analyst of each of the rank ordered learned analyst profiles.

In any of the disclosed embodiments of the method, the method may also include adding the problem ticket to the learned problem profile, when the categorization algorithm may identify the match between the problem and the associated problem information and the learned problems and the associated learned problem information. The method may further include adding the problem ticket including the problem and the associated problem information to a new learned problem profile that may have a new problem category to the learned problem profile database, when the categorization algorithm may be unable to identify the match.

In any of the disclosed embodiments of the method, the method may also include, for each of one or more completed problem tickets in an operational database, retrieving an assigned analyst, analyst information associated with the assigned analyst, a known learned problem profile in the learned problem profile database associated with the completed problem ticket, and performance metrics associated with the assigned analyst and the completed problem ticket from an operational database, and adding the analyst information and the performance metrics to a learned analyst profile in the learned analyst profile database that may be associated with the assigned analyst.

In any of the disclosed embodiments of the method, the method may also include searching a knowledge database by using a knowledge matching algorithm that may identify a match between the problem and the associated problem information of the problem ticket and one or more matching knowledge articles for resolution of the problem of the problem ticket. The method may also include adding the one or more matching knowledge articles for resolution of the problem to the problem ticket and the learned problem profile, prior to the assignment of one of the analysts of the rank ordered learned analyst profiles to the problem ticket. The one or more matching knowledge articles may include instructions for resolution of a completed problem ticket.

In any of the disclosed embodiments of the method, the method may also include creating a problem ticket reference number for the problem ticket, adding the problem ticket reference number to the problem ticket, and sending the problem ticket reference number to the client information handling system.

In any of the disclosed embodiments of the method, the method may also include detecting, by a client processor subsystem of the client information handling system, an occurrence of the problem during execution of an application by the client processor subsystem. The method may further include, in response to the occurrence of the problem and a user request from a user interface, collecting the problem information associated with the occurrence of the problem, creating the problem ticket including the problem information, sending the problem ticket to the ticketing information handling system, receiving a problem ticket reference number associated with the problem ticket from the ticketing information handling system, and providing the problem ticket reference number to the user interface for user notification.

In any of the disclosed embodiments of the method, the categorization algorithm may be an anytime optimal search-based algorithm.

In any of the disclosed embodiments of the method, the problem information may include one or more of an error message, an error code, an exception code, a screenshot of information that may be displayed by a user interface on a display of the client information handling system, a page name and a page header of the information that may be displayed by the user interface on the display, a transaction name, a product name, a business process name, a business domain name, a problem severity, a submission time, a selected problem priority, an accepted problem priority, an adjusted SLA, an accepted SLA, and analyst email that may be associated with the problem of the problem ticket that may be associated with the problem information.

In any of the disclosed embodiments of the method, the performance metrics may include one or more of a customer satisfaction score, a service level agreement metric, and a reoccurrence metric.

In any of the disclosed embodiments of the method, the analyst information may include one or more of a business domain, shift information, a time zone, a holiday zone, a start date, a current work load, and a next available time.

In any of the disclosed embodiments of the method, the user information may include one or more of a business domain, shift information, a time zone, a holiday zone, contact information, analyst preferences, a next available time, and a SLA associated with a user.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system;

FIG. 2 is a block diagram of selected elements of an embodiment of a ticketing system;

FIG. 3 is a flow chart of selected elements of a method for intelligent ticket assignment through self-categorizing problems and self-rating analysts;

FIG. 4 is a flow chart of selected elements of a method for building learned problem profiles;

FIG. 5 is a flow chart of selected elements of a method for building learned analyst profiles;

FIG. 6 is a flow chart of selected elements of a method for searching a knowledge database to identify knowledge articles for resolution of a problem; and

FIG. 7 is a flow chart of selected elements of a method for creating a problem ticket and user notification.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and flash memory (SSD); as well as communications media such wires, optical fibers, microwaves, radio waves, and other electromagnetic or optical carriers; or any combination of the foregoing.

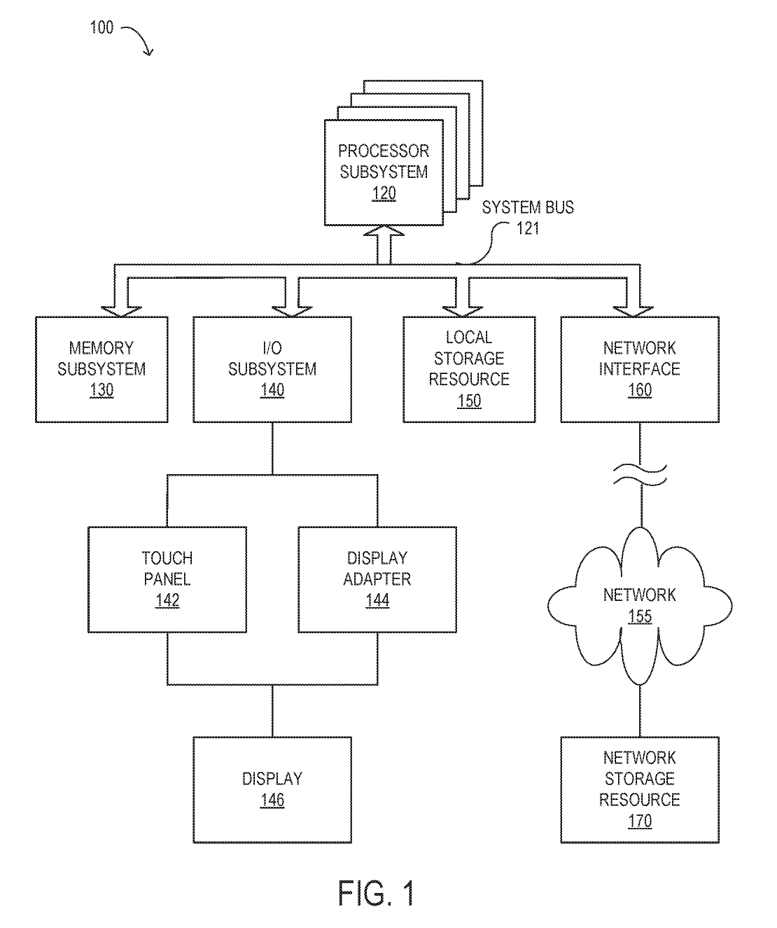

Particular embodiments are best understood by reference to FIGS. 1, 2, 3, 4, 5, 6, and 7 wherein like numbers are used to indicate like and corresponding parts.

Turning now to the drawings, FIG. 1 illustrates a block diagram depicting selected elements of an embodiment of information handling system 100. As shown in FIG. 1, components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 1, network interface 160 may be a suitable system, apparatus, or device operable to serve as an interface between information handling system 100 and a network 155. Network interface 160 may enable information handling system 100 to communicate over network 155 using a suitable transmission protocol and/or standard, including, but not limited to, transmission protocols and/or standards enumerated below with respect to the discussion of network 155. In some embodiments, network interface 160 may be communicatively coupled via network 155 to a network storage resource 170. Network 155 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network 155 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 155 and its various components may be implemented using hardware, software, or any combination thereof.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down. Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Likewise, network storage resource 170 may comprise computer-readable media (e.g., hard disk drive, floppy disk drive, CD-ROM, and/or other type of rotating storage media, flash memory, EEPROM, and/or other type of solid state storage media) and may be generally operable to store instructions and/or data. In system 100, I/O subsystem 140 may comprise a system, device, or apparatus generally operable to receive and/or transmit data to/from/within system 100. I/O subsystem 140 may represent, for example, a variety of communication interfaces, graphics interfaces, video interfaces, user input interfaces, and/or peripheral interfaces. As shown, I/O subsystem 140 may comprise touch panel 142 and display adapter 144. Touch panel 142 may include circuitry for enabling touch functionality in conjunction with a display 146 that is driven by display adapter 144. A ticketing system may include a client information handling system 100-1, a ticketing information handling system 100-2, and a network 155 coupled to both client information handling system 100-1 and ticketing information handling system 100-2, described in further detail below.

As will be described in further detail herein, in operation, a client information handling system may be utilized to execute a user application, such as information handling system 100-1. A problem may occur during execution of the user application and a user may request help from customer support to resolve the problem. Typically, the user submits the problem to customer support using a ticket submission system, which may be a third party ticket submission system. The ticket submission system may require the user to provide a description of the problem, the name of the user application, the priority of the problem, the severity of the problem, among other information associated with the problem. The ticket submission system may send the problem ticket including the problem and the information associated with the problem to an information handling system, such as information handling system 100. Information handling system 100 may assign the problem ticket to the first analyst of a customer support team that becomes available to work on the problem ticket using a round-robin ticket assignment method. The amount of time to resolve a given problem of a problem ticket depends on the analyst assigned and their level of expertise to resolve the given problem. If the first analyst is unable to resolve the problem due to a low level of expertise, information handling system 100 may need to re-assign the problem to another analyst that becomes available to work on the problem ticket using the same round-robin ticket assignment method. The knowledge level varies from analyst to analyst and each analyst's level of expertise varies from problem to problem. As such, the amount of time to successfully resolve a particular problem may vary from an acceptable amount of time to an unacceptable amount of time based on the analyst assigned to the problem. As such, using a round-robin ticket assignment method to assign problems to analysts is not effective and impacts the analysts' effectiveness and efficiency, and the user's satisfaction.

Therefore, a ticketing system that may enable intelligent ticket assignment of problem tickets to analysts of customer support teams by self-categorizing the problems, self-rating the analysts, and learning from both historical and real-time operational data to perform real-time problem categorization to build problem and analyst profiles, may allow analysts that are subject matter experts to be linked to problem profiles with every incoming problem ticket and the incoming problem tickets to be intelligently assigned to the analysts having the expertise to resolve those problem tickets. The ticketing system may continue to learn and improve the building of the problem profiles and the analyst profiles and improve the problem to analyst correlation, which may result in improved analyst effectiveness and efficiency and user satisfaction, as described in further detail herein.

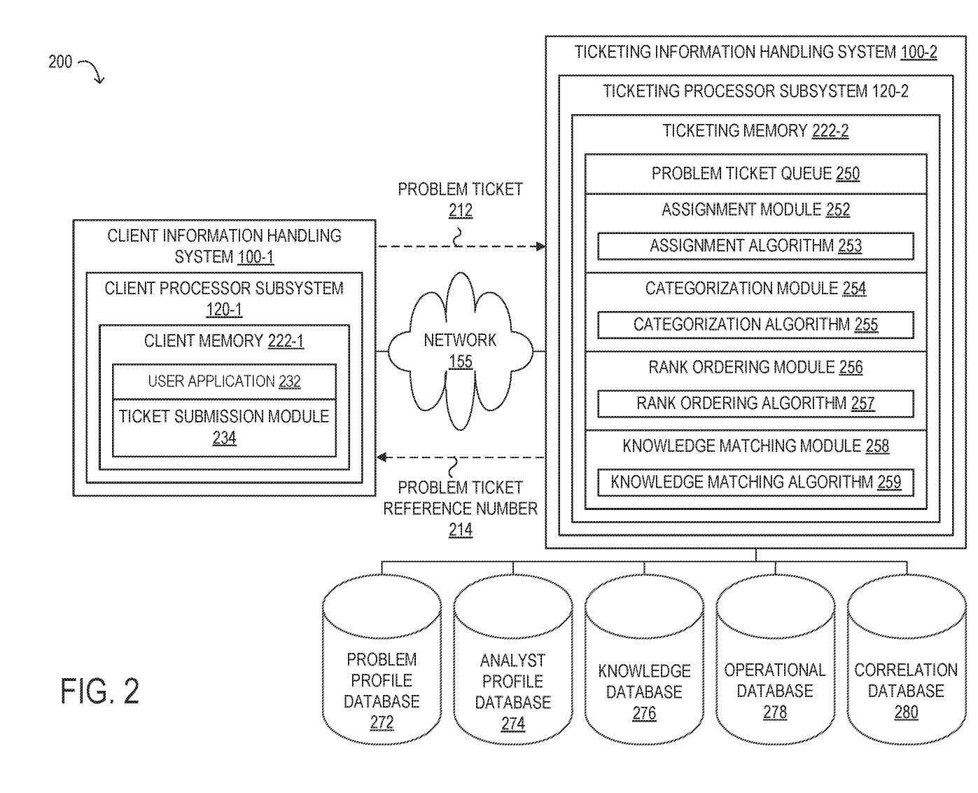

Turning now to FIG. 2, a block diagram of selected elements of an embodiment of a ticketing system 200 is illustrated. In FIG. 2, ticketing system 200 is shown in a schematic representation and is not drawn to scale or perspective. It is noted that, in different embodiments, ticketing system 200 may be operated with additional or fewer elements.

As shown in FIG. 2, components of ticketing system 200 may include, but are not limited to, a client information handling system 100-1 and a ticketing information handling system 100-1 that may be coupled to client information handling system 100-1. In one or more embodiments, client information handling system 100-1 may host a web server that may allow a user to interact with web pages via a browser interface that are controlled and managed by the web server. Ticketing system 200 may also include network 155 that may be coupled to client information handling system 100-1 and ticketing information handling system 100-1.

Client information handling system 100-1 may include a client processor subsystem 120-1 that may have a client processor and a client memory 222-1, as described above with respect to processor subsystem 120. During operation, client processor subsystem 120-1 may execute a user application 232 that may have a user interface, which may be stored at client memory 222-1, and may detect an occurrence of a problem during execution of user application 232 by client processor subsystem 120-1. User application 232 may be a business application, a web based application, or other types of applications. The user interface of user application 232 may be an application browser interface or other types of application interfaces. The problem may be an error, an exception, and other types of problems that may occur during execution of an application. The problem may be presented to a user of user application 232 using the user interface of user application 232. The user may request help to resolve the problem by clicking a submit ticket button that may be installed as a plugin to the user interface to provide the user request to the user interface.

Client processor subsystem 120-1 may, in response to one or more of the occurrence of the problem and the user request from the user interface execute a ticket submission module 234, which may be stored at client memory 222-1, to collect problem information that may be associated with the occurrence of the problem. The problem information may include one or more of a problem description of the problem that may be in text form, an error message, an error code, an exception code, a screenshot of information that may be displayed by the user interface on display 146 of client information handling system 100-1, a name and a header of a web page that may be displayed by the user interface on display 146, a transaction name, a product name that may be associated with user application 232, a business process name that may be associated with user application 232, a business domain name that may be associated with user application 232, a problem severity, a submission time, and a selected problem priority. The problem information may also include an accepted problem priority, an adjusted service level agreement (SLA), an accepted SLA, a problem resolution time, and an analyst email associated with the problem, which may be added during further processing of the problem. Client processor subsystem 120-1 may create a problem ticket 112 that may include the problem and the problem information. Problem ticket 112 may also include user information associated with the user. The user information may include one or more of a business domain, shift information, a time zone, a holiday zone, contact information, analyst preferences, a next available time, and a SLA associated with the user. Client processor subsystem 120-1 may send problem ticket 212 to ticketing information handling system 100-2. Client processor subsystem 120-1 may, in response to reception of a problem ticket reference number 214 that may be associated with problem ticket 212 from ticketing information handling system 100-2, provide problem ticket reference number 214 to the user interface for user notification. Problem ticket reference number 214 may be provided and presented to the user of user application 232 using the user interface of user application 232.

Ticketing information handling system 100-2 may be coupled to a learned problem profile database 272, a learned analyst profile database 274, a knowledge database 276, an operational database 278, and a correlation database 280. Network storage resource 170, memory subsystem 130-2 of ticketing information handling system 100-2, and local storage resource 150-2 of ticketing information handling system 100-2 may include one or more of learned problem profile database 272, learned analyst profile database 274, knowledge database 276, operational database 278, and correlation database 280. Ticketing information handling system 100-2 may include a ticketing processor subsystem 120-2, which may have a ticketing processor and a ticketing memory 222-2, as previously described with respect to processor subsystem 120. Ticketing memory 222-2 may store a problem ticket queue 250, an assignment module 252 to implement an assignment algorithm 253, a categorization module 254 to implement a categorization algorithm 255, a rank ordering module 256 to implement a rank ordering algorithm 257, and a knowledge matching module 258 to implement a knowledge matching algorithm 259.

During operation, ticketing processor subsystem 120-2 may receive problem ticket 212 that may include the problem and the problem information from client information handling system 100-1. Ticketing processor subsystem 120-2 may create problem ticket reference number 214 associated with problem ticket 212. Ticketing processor subsystem 120-2 may add problem ticket reference number 214 to problem ticket 212 to allow the components of ticketing system 200 to associate problem ticket 212 with problem ticket reference number 214. Ticketing processor subsystem 120-2 may send problem ticket reference number 214 associated with problem ticket 212 to client information handling system 100-1. Alternatively, ticketing processor subsystem 120-2 may send problem ticket 212 including associated problem ticket reference number 214 to client information handling system 100-1.

Ticketing processor subsystem 120-2 may create a first problem profile pattern for the problem of problem ticket 212 from the problem information of problem ticket 212 by identifying various keywords in the problem information of problem ticket 212. In one or more embodiments, the various keywords may be in the problem description of problem ticket 212. Ticketing processor subsystem 120-2 may categorize the first problem profile pattern by using categorization algorithm 255 to determine whether the first problem profile pattern has a known learned problem profile pattern that may be associated with a respective known learned problem profile of known learned problem profiles of learned problem profile database 272. Building the learned problem profiles of learned problem profile database 272 is described in further detail below. Categorization algorithm 255 may be an anytime optimal search-based algorithm that finds high-quality problem profile pattern matches and continuously learns and improves the relations between the first problem profile pattern, e.g. the various keywords in the problem information of problem ticket 212, and the known problem profile patterns of the known learned problem profiles, e.g. various keywords in the knowledge articles of knowledge database 276 associated with the known problem profile patterns of the known learned problem profiles. In one or more embodiments, categorization algorithm may assign a weighting value to each of the various keywords and utilize those weighting values when finding matches. Categorization algorithm 255 may calculate each best match value for a best match of the first problem profile pattern of problem ticket 312 to each of the known learned problem profile patterns of the respective known learned problem profiles. Categorization algorithm 255 may determine the highest calculated best match value for the best match of the first problem profile pattern to the known learned problem profile pattern of the respective known learned problem profile. Categorization algorithm 255 may compare the highest calculated best match value to a best match threshold value. When the highest calculated best match value is greater than or equal to the best match threshold value, ticketing processor subsystem 120-2 may add problem ticket 212 to the known learned problem profile associated with the highest calculated best match value. When the highest calculated best match value is less than the best match threshold value, ticketing processor subsystem 120-2 may add a new learned problem profile that may have problem ticket 212, problem information 214, and the first problem profile pattern to learned problem profile database 272. Ticketing processor subsystem 120-2 may identify a learned problem profile of learned problem profile database 272 that may be associated with the problem of problem ticket 212 based on the categorization results of the problem by categorization algorithm 255. When the highest calculated best match value is greater than or equal to the best match threshold value, the learned problem profile may be the known learned problem profile associated with the highest calculated best match value. When the calculated best match value is less than the best match threshold value, the learned problem profile may be the new learned problem profile.

In one or more embodiments, ticketing processor subsystem 120-2 may build and maintain problem profile database 272 by creating and adding learned problem profiles to problem profile database 272. Ticketing processor subsystem 120-2 may, for each of one or more completed problem tickets in operational database 278 retrieve a completed problem ticket, a completed problem associated with the completed problem ticket, and completed problem information associated with the completed problem from the operational database. Ticketing processor subsystem 120-2 may create a completed problem profile pattern for the completed problem from the completed problem information associated with the completed problem, categorize the completed problem profile pattern to create a completed problem profile associated with the completed problem and the completed problem information, and add the completed problem profile to problem profile database 272, as previously described.

Ticketing processor subsystem 120-2 may search knowledge database 276 by using knowledge matching algorithm 259 to identify one or more matching knowledge articles for resolution of the problem associated with problem ticket 212 that may be based on problem ticket 212, the problem associated with problem ticket 212, and the problem information associated with the problem. Knowledge database (KDB) 276 may include KDB entries, each KDB entry may include a KDB problem ticket, a KDB problem associated with the KDB problem ticket, KDB problem information associated with the KDB problem, and one or more knowledge articles for resolution of the KDB problem. Knowledge matching algorithm 259 may be an anytime optimal search-based algorithm, similar to categorization algorithm 255 as previously described, that finds high-quality problem profile pattern matches of the problem and associated information of problem ticket 212 with the knowledge articles of knowledge database 276 associated with the known problem profile patterns of the known learned problem profiles.

Knowledge matching algorithm 259 may calculate each best match value for a best match of problem ticket 212 and the problem and associated problem information associated with problem ticket 212 to each of the KDB problem tickets and the KDB problems and associated KDB problem information associated with each of the KDB problem tickets of respective existing KDB entries of knowledge database 276. For each calculated best match value calculated for problem ticket 212 and the problem and associated problem information associated with problem ticket 212 and each KDB problem ticket and KDB problem and the associated KDB problem information associated with the KDB problem tickets of the respective existing KDB entry of KDB 276, compare the calculated best match value to a best match threshold value. When the calculated best match value is greater than or equal to the best match threshold value, ticketing processor subsystem 120-2 may add a matching knowledge article and associated resolution instructions, which may be a best match of problem ticket 212 and the problem and associated problem information associated with problem ticket 212 with the KDB problem ticket and the KDB problem and the associated KDB problem information, to one or more of the learned problem profile associated with problem ticket 212 and problem ticket 212.

In one or more embodiments, ticketing processor subsystem 120-2 may also add one or more of a knowledge article identification associated with the matching knowledge article, a cross-reference for the matching knowledge article, the KDB problem associated with the KDB problem ticket, the KDB problem information associated with the KDB problem, a KDB problem complexity estimate, e.g. amount of effort required to resolve the KDB problem, and a KDB time estimate to resolve the problem to one or more of the learned problem profile associated with problem ticket 212 and problem ticket 212. The matching knowledge article includes instructions and information to enable an analyst to resolve the associated problem. By adding the matching knowledge articles to problem ticket 212, all of the information is already available when an analyst starts working on problem ticket 212 in order to resolve the problem more efficiently.

In one or more embodiments, ticketing processor subsystem 120-2 may create a first set of problem categories for the problems in learned problem profile database 272 based on the most repeated keywords in the problem description for each of the product names of the learned problem profile of learned problem profile database 272. Next, the knowledge articles used to resolve the problems in learned problem profile database 272 is mapped to the first set of problem categories. The most used knowledge articles applied to resolving the problems in the particular problem categories are then grouped into a second set of problem categories. Ticketing processor subsystem 120-2 may continuously sort the sets of problem categories based on problem descriptions and associated knowledge articles of learned problem profile database 272 and rearrange the problem groupings and problem categories based on the learning. In one or more embodiments, ticketing processor subsystem 120-2 may combine problem categories to create new problem categories, where a new problem category may have a broader spread of keywords and knowledge articles. For example, some knowledge articles may be related to more than one category of learned problem profiles.

Ticketing processor subsystem 120-2 may build, maintain, and update learned analyst profile database 274 by creating and adding learned analyst profiles to learned analyst profile database 274. In one or more embodiments, a configuration process, an initialization process, an update process, and other types of processes may create learned analyst profiles from a list of known analysts and associated analyst information, and add these learned analyst profiles to learned analyst profile database 274. The analyst information may include one or more of a business domain, shift information, a time zone, a holiday zone, a start date, and a next available time. The analyst information may also include a current work load associated with an analyst, which may be added to the associated learned analyst profile of learned analyst profile database 274 during further processing of the learned analyst profile.

Ticketing processor subsystem 120-2 may, for each of one or more completed problem tickets in operational database 278 retrieve an assigned analyst associated with a completed problem ticket, analyst information that may be associated with the assigned analyst and performance metrics that may be associated with the assigned analyst and the completed problem ticket from operational database 278. The performance metrics may include one or more of a customer satisfaction score, a service level agreement metric, a reoccurrence metric, a problem acknowledgment time, and a problem resolution time. Ticketing processor subsystem 120-2 may, for each of one or more completed problem tickets in operational database 278 retrieve a known learned problem profile that may be associated with the completed problem ticket from learned problem profile database 272. Ticketing processor subsystem 120-2 may, for each of one or more completed problem tickets in operational database 278, add the analyst information, a cross-reference to the known learned problem profile, and the performance metrics to a learned analyst profile in learned analyst profile database 274 that may be associated with the assigned analyst.

In one or more embodiments, ticketing processor subsystem 120-2 may, for each of one or more completed problem tickets in operational database 278, also add a cross-reference of the learned analyst profile associated with the completed problem ticket, a cross-reference of the rank ordered learned analyst profiles associated with the known learned problem profile, and a cross reference of the known learned problem profile to a correlation database entry of correlation database 280. Building and maintaining correlation database 280 in this manner allows for the efficient identification of analysts that are effective at resolving problems associated with the known learned problem profile, for example, identifying the analyst with the highest customer satisfaction score for resolving these types of problems.

Ticketing processor subsystem 120-2 may, for each of one or more completed problem tickets in operational database 278, order the learned analyst profiles that may be associated with the known learned problem profile associated with the completed problem ticket by using rank ordering algorithm 257 that may be based on the performance metrics of one of the learned analyst profiles associated with the known learned problem profile, and the performance metrics of each of the other learned analyst profiles associated with the known learned problem profile. Rank ordering algorithm 257 may order the learned analyst profiles from a learned analyst profile having a highest rank order value to a learned analyst profile having a lowest rank order value to create the rank ordered learned analyst profiles by comparing each rank order value of each of the learned analyst profiles to each rank order value of each of the other learned analyst profiles. When the rank order value of one of the learned analyst profiles is greater than the rank order values of each of the other learned analyst profiles, the rank order value of the one of the learned analyst profiles is the highest rank order value. The rank order value may be a value associated with the performance metrics associated with an analyst associated with the learned analyst profile and the learned problem profile, where high rank order values correlate to high performance metric values. For example, the rank order value may be associated with the analyst and the learned problem profile and may be a value associated with a customer satisfaction score, a problem ticket closure rate, a SLA metric (e.g. meeting the SLA, exceeding the SLA, or missing the SLA), a reoccurrence metric (e.g. how many times it takes for an analyst to resolve a problem associated with the known learned problem profile), a problem acknowledgment time, a problem resolution time, or a value associated with a combination of one or more of these values.

Ticketing processor subsystem 120-2 may, for each of one or more completed problem tickets in operational database 278, add a cross-reference of the learned analyst profile associated with the completed problem ticket and a cross-reference of the rank ordered learned analyst profiles to the known learned problem profile. Ticketing processor subsystem 120-2 may, for each of one or more completed problem tickets in operational database 278, also add a cross-reference of the learned analyst profile associated with the completed problem ticket, a cross-reference of the rank ordered learned analyst profiles associated with the known learned problem profile, and a cross reference of the known learned problem profile to a correlation database entry of correlation database 280. Building and maintaining correlation database 280 in this manner allows for the efficient identification of analysts that are effective at resolving problems associated with the known learned problem profile, for example, identifying the analyst with the highest customer satisfaction score for resolving these types of problems.

Ticketing processor subsystem 120-2 may assign one of the analysts of rank ordered learned analyst profiles associated with a known learned problem profile of learned problem profile database 272 associated with problem ticket 212 to problem ticket 212 using assignment algorithm 253 that may be based on analyst information of each of the analysts of the rank ordered learned analyst profiles of learned analyst profile database 274. Assignment algorithm 253 may retrieve the rank ordered learned analyst profiles from the known learned problem profile using cross-references of the rank ordered learned analyst profiles. Alternatively, assignment algorithm 253 may retrieve the rank ordered learned analyst profiles using a cross-reference of the rank ordered learned analyst profiles of a correlation database entry of correlation database 280 associated with the known learned problem profile. Assignment algorithm 253 may select a learned analyst profile that may have a rank order value that is the highest rank order value of the rank ordered learned analyst profiles with an analyst that may have availability for problem ticket 212 based on analyst information associated with the analyst. Assignment algorithm 253 may assign problem ticket 212 to the analyst associated with the selected learned analyst profile. Assigning problem tickets in this manner ensures that an available analyst with the most expertise in resolving these particular types of problems may be assigned to the problem tickets.

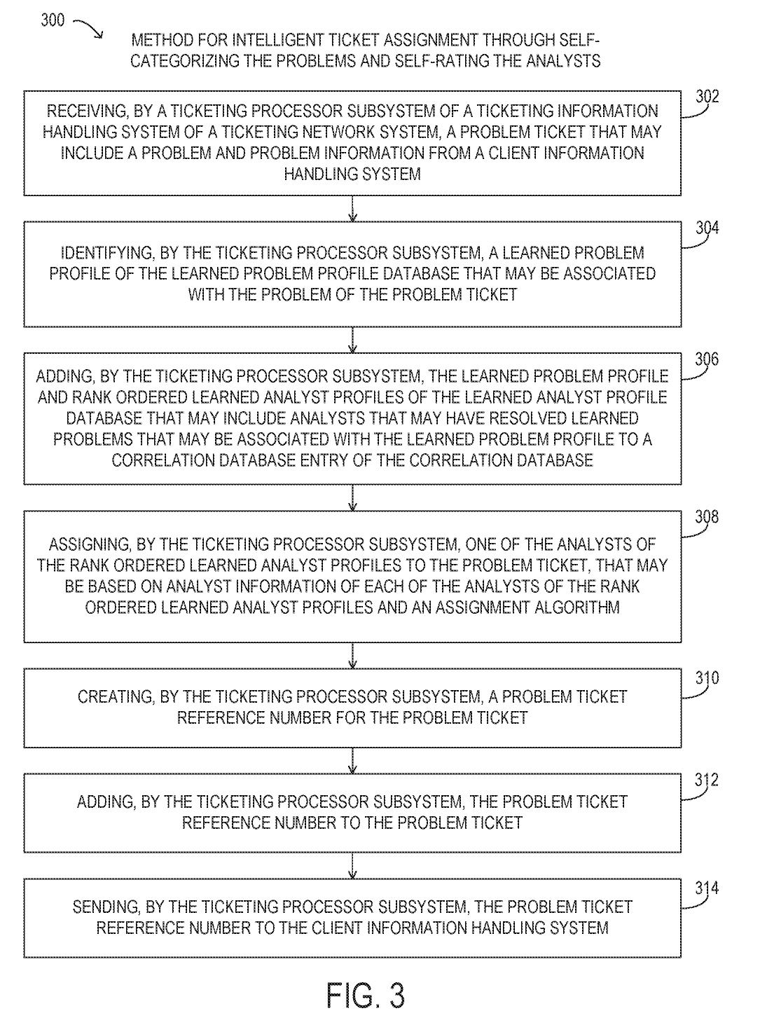

Referring now to FIG. 3, a flow chart of selected elements of a method 300 for intelligent ticket assignment through self-categorizing problems and self-rating analysts, as described herein, is depicted in flowchart form. Method 300 may be performed using ticketing information handling system 100-2, in conjunction with a client information handling system 100-1 (see FIGS. 1 and 2) and, in particular, by ticketing processor subsystem 120-2 and an assignment module 252 executed by a processor of the ticketing processor subsystem 120-2. It is noted that certain operations described in method 300 may be optional or may be rearranged in different embodiments.

Method 300 may begin at, step 302, by receiving, by a ticketing processor subsystem of a ticketing information handling system, a problem ticket that may include a problem and problem information from a client information handling system. The ticketing information handling system may be coupled to the client information handling system, a learned problem profile database, a learned analyst profile database, and a correlation database. At step 304, the ticketing processor subsystem may identify a learned problem profile of the learned problem profile database that may be associated with the problem of the problem ticket. At step 306, the ticketing processor subsystem may add the learned problem profile and rank ordered learned analyst profiles of the learned analyst profile database that may include analysts that may have resolved learned problems that may be associated with the learned problem profile to a correlation database entry of the correlation database. At step 308, the ticketing processor subsystem may assign one of the analysts of the rank ordered learned analyst profiles to the problem ticket that may be based on analyst information of each of the analysts of the rank ordered learned analyst profiles and an assignment algorithm. The assignment algorithm may be implemented by an assignment module of the ticketing processor subsystem. At step 310, the ticketing processor subsystem may create a problem ticket reference number for the problem ticket. At step 312, the ticketing processor subsystem may add the problem ticket reference number to the problem ticket. At step 314, the ticketing processor subsystem may send the problem ticket reference number to the client information handling system.

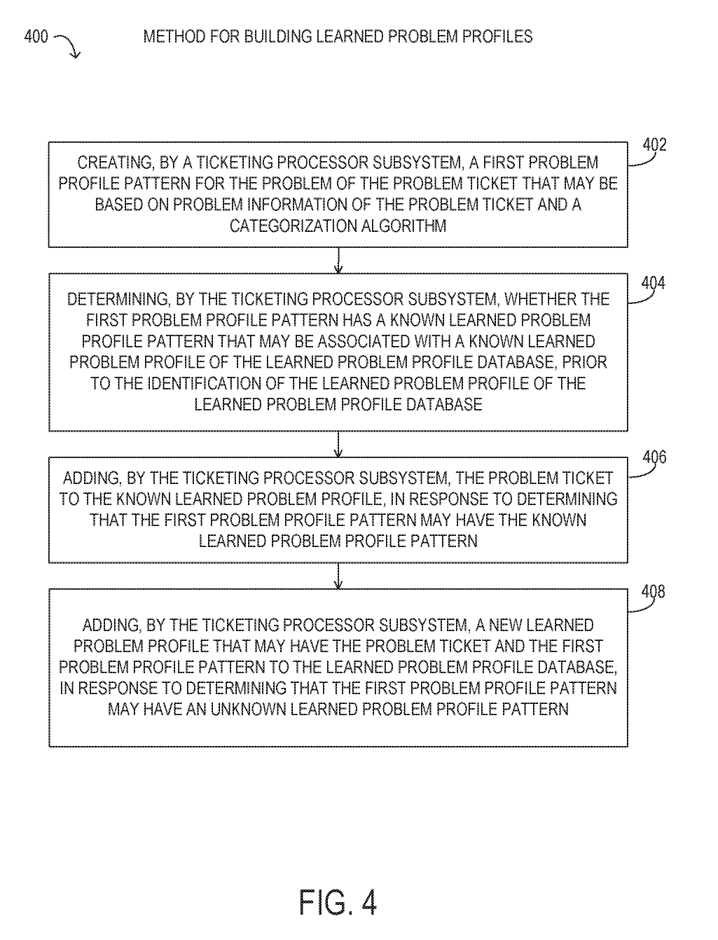

Referring now to FIG. 4, a flow chart of selected elements of a method 400 for building learned problem profiles, as described herein, is depicted in flowchart form. Method 400 may be performed using ticketing information handling system 100-2 (see FIGS. 1 and 2) and, in particular, by ticketing processor subsystem 120-2 and a categorization module 254 executed by a processor of the ticketing processor subsystem 120-2. It is noted that certain operations described in method 400 may be optional or may be rearranged in different embodiments.

Method 400 may begin at, step 402, by creating, by a ticketing processor subsystem, a first problem profile pattern for the problem of the problem ticket that may be based on problem information of the problem ticket and a categorization algorithm. At step 404, the ticketing processor subsystem may determine whether the first problem profile pattern has a known learned problem profile pattern that may be associated with a known learned problem profile of the learned problem profile database, prior to the identification of the learned problem profile of the learned problem profile database. At step 406, the ticketing processor subsystem may add the problem ticket to the known learned problem profile, in response to determining that the first problem profile pattern may have the known learned problem profile pattern. At step 408, the ticketing processor subsystem may add a new learned problem profile that may have the problem ticket and the first problem profile pattern to the learned problem profile database, in response to determining that the first problem profile pattern may have an unknown learned problem profile pattern. The categorization algorithm may be implemented by a categorization module of the ticketing processor subsystem.

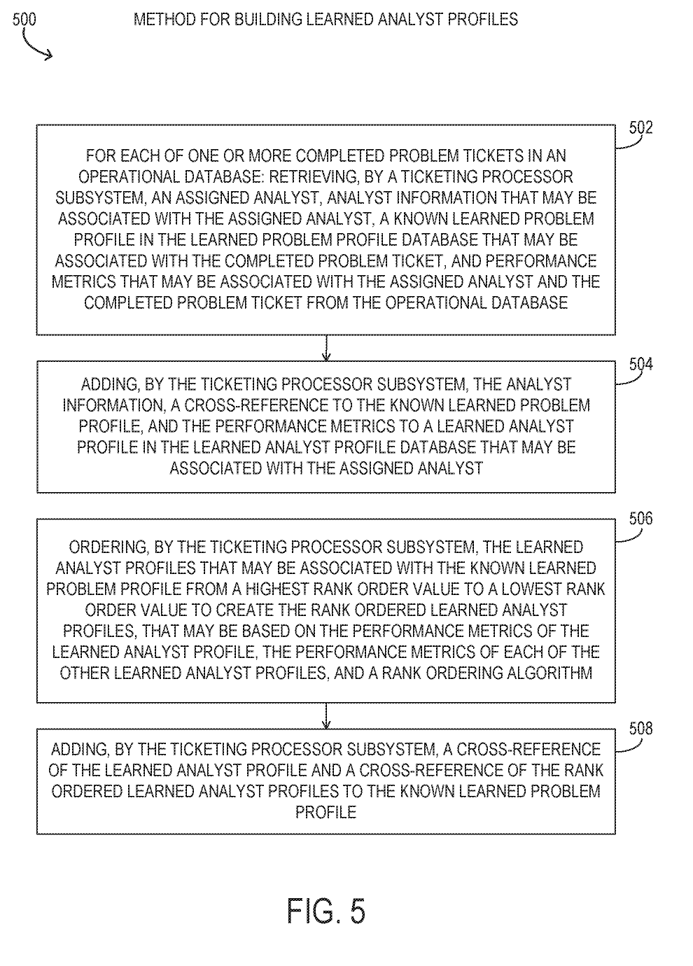

Referring now to FIG. 5, a flow chart of selected elements of a method 500 for building learned analyst profiles, as described herein, is depicted in flowchart form. Method 500 may be performed using ticketing information handling system 100-2 (see FIGS. 1 and 2) and, in particular, by ticketing processor subsystem 120-2 and a rank ordering module 256 executed by a processor of the ticketing processor subsystem 120-2. It is noted that certain operations described in method 500 may be optional or may be rearranged in different embodiments.

Method 500 may begin at, step 502, by, for each of one or more completed problem tickets in an operational database, retrieving, by the ticketing processor subsystem, an assigned analyst, analyst information that may be associated with the assigned analyst, a known learned problem profile in the learned problem profile database that may be associated with the completed problem ticket, and performance metrics that may be associated with the assigned analyst and the completed problem ticket from the operational database. At step 504, for each of one or more completed problem tickets in an operational database, the ticketing processor subsystem may add the analyst information, a cross-reference to the known learned problem profile, and the performance metrics to a learned analyst profile in the learned analyst profile database that may be associated with the assigned analyst. At step 506, for each of one or more completed problem tickets in an operational database, the ticketing processor subsystem may order the learned analyst profiles that may be associated with the known learned problem profile from a highest rank order value to a lowest rank order value to create the rank ordered learned analyst profiles, that may be based on the performance metrics of the learned analyst profile, the performance metrics of each of the other learned analyst profiles, and a rank ordering algorithm. At step 508, for each of one or more completed problem tickets in an operational database, the ticketing processor subsystem may add a cross-reference of the learned analyst profile and a cross-reference of the rank ordered learned analyst profiles to the known learned problem profile. The operational database may be coupled to the ticketing information handling system and the rank ordering algorithm may be implemented by a rank ordering module of the ticketing processor subsystem.

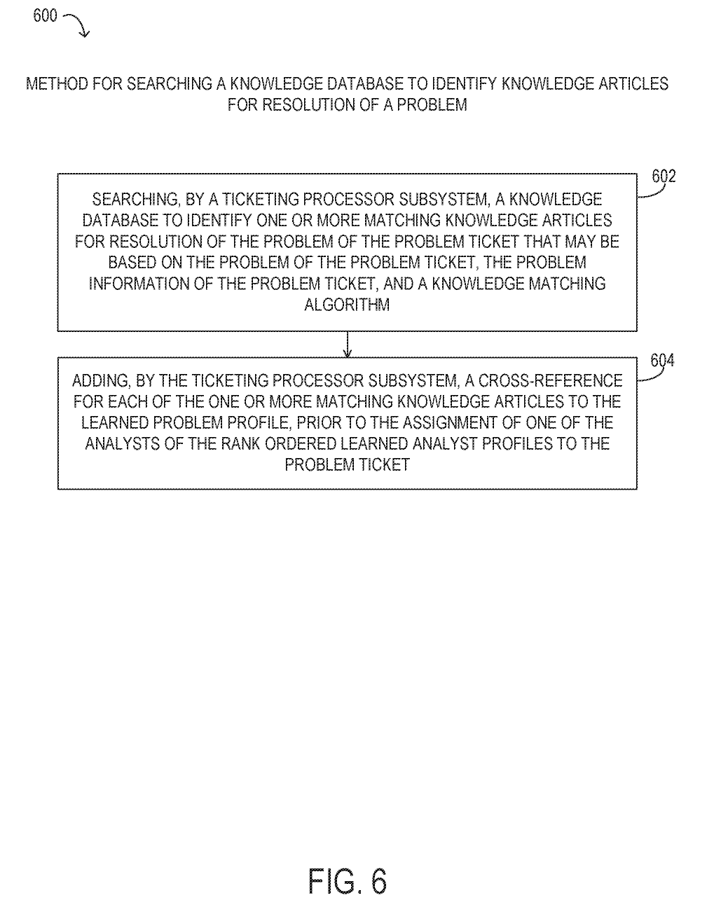

Referring now to FIG. 6, a flow chart of selected elements of a method 600 for searching a knowledge database to identify knowledge articles for resolution of a problem, as described herein, is depicted in flowchart form. Method 600 may be performed using ticketing information handling system 100-2 (see FIGS. 1 and 2) and, in particular, by ticketing processor subsystem 120-2. It is noted that certain operations described in method 600 may be optional or may be rearranged in different embodiments.

Method 600 may begin at, step 602, by searching, by a ticketing processor subsystem, a knowledge database to identify one or more matching knowledge articles for resolution of the problem of the problem ticket that may be based on the problem of the problem ticket, the problem information of the problem ticket, and a knowledge matching algorithm. At step 604, the ticketing processor subsystem may add a cross-reference for each of the one or more matching knowledge articles to the learned problem profile, prior to the assignment of one of the analysts of the rank ordered learned analyst profiles to the problem ticket. The knowledge database may be coupled to the ticketing information handling system and may include one or more knowledge articles; each knowledge article may include instructions for resolution of a completed problem ticket. The knowledge matching algorithm may be implemented by a knowledge matching module of the ticketing information handling system.

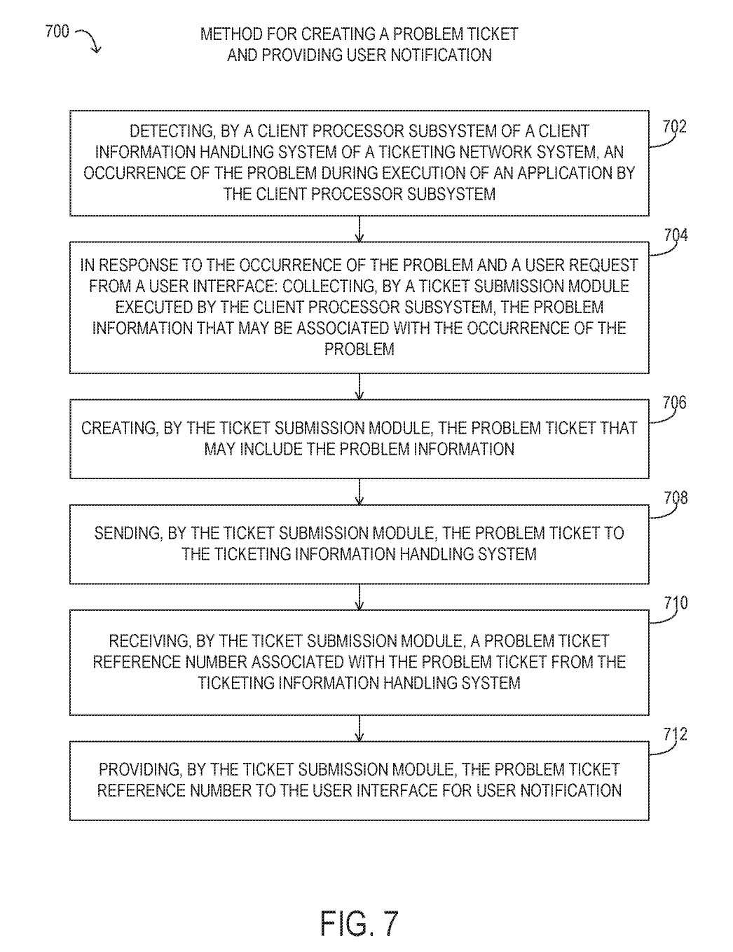

Referring now to FIG. 7, a flow chart of selected elements of a method 700 for creating a problem ticket and user notification, as described herein, is depicted in flowchart form. Method 700 may be performed using client information handling system 100-1 (see FIGS. 1 and 2) and, in particular, by client processor subsystem 120-1 and a ticket submission module 234 executed by a processor of processor subsystem 120-1. It is noted that certain operations described in method 700 may be optional or may be rearranged in different embodiments.

Method 700 may begin at step 702, by detecting, by a client processor subsystem of the client information handling system, an occurrence of a problem during execution of an application by the client processor subsystem. At step 704, a ticket submission module executed by the client processor subsystem, in response to the occurrence of the problem and a user request from a user interface, may collect problem information that may be associated with the occurrence of the problem. At step 706, the ticket submission module, in response to the occurrence of the problem and a user request from a user interface, may create the problem ticket that may include the problem information. At step 708, the ticket submission module, in response to the occurrence of the problem and a user request from a user interface, may send the problem ticket to the ticketing information handling system. At step 710, the ticket submission module, in response to the occurrence of the problem and a user request from a user interface, may receive a problem ticket reference number associated with the problem ticket from the ticketing information handling system. At step 712, the ticket submission module, in response to the occurrence of the problem and a user request from a user interface, may provide the problem ticket reference number to the user interface for user notification. The client processor subsystem may further include the application and the ticket submission module. The application and the ticket submission module may be associated with the user interface.

As disclosed herein, systems and methods for intelligent ticket assignment through self-categorizing the problems and self-rating the analysts may include a client information handling system and a ticketing information handling system that may have a ticketing processor subsystem. The ticketing processor subsystem may receive a problem ticket that may include a problem and associated problem information from the client information handling system. The ticketing processor subsystem may also categorize the problem into a problem category of a learned problem profile. The ticketing processor subsystem may also perform a rank ordering algorithm to order learned analyst profiles of analysts that may have resolved one or more of the learned problems associated with the learned problem profile. The ticketing processor subsystem may also assign one of the analysts of the rank ordered learned analyst profiles to the problem ticket.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A ticketing system, comprising:
a client information handling system; and
a ticketing information handling system coupled to the client information handling system, a learned problem profile database, and a learned analyst profile database, and including:
a ticketing processor subsystem configured to:
receive a problem ticket including a problem and associated problem information from the client information handling system;
categorize the problem of the problem ticket into a problem category of a learned problem profile of the learned problem profile database by using a categorization algorithm to identify a match between the problem and the associated problem information and learned problems and associated learned problem information of the learned problem profile;
perform a rank ordering algorithm to order learned analyst profiles of the learned analyst profile database based on performance metrics associated with the learned problem profile and a respective analyst of each of the learned analyst profiles, wherein the respective analyst of each of the learned analyst profiles has resolved one or more of the learned problems associated with the learned problem profile; and
assign one of the analysts of the rank ordered learned analyst profiles to the problem ticket by using an assignment algorithm based on analyst information associated with the respective analyst of each of the rank ordered learned analyst profiles.

2. The ticketing system of claim 1, the ticketing processor subsystem further configured to:
add the problem ticket to the learned problem profile, when the categorization algorithm identifies the match between the problem and the associated problem information and the learned problems and the associated learned problem information; and
add the problem ticket including the problem and the associated problem information to a new learned problem profile having a new problem category to the learned problem profile database, when the categorization algorithm is unable to identify the match.

3. The ticketing system of claim 1, the ticketing processor subsystem further configured to:
for each of one or more completed problem tickets in an operational database:
retrieve an assigned analyst, analyst information associated with the assigned analyst, a known learned problem profile in the learned problem profile database associated with the completed problem ticket, and performance metrics associated with the assigned analyst and the completed problem ticket from the operational database; and
add the analyst information and the performance metrics to a learned analyst profile in the learned analyst profile database associated with the assigned analyst.

4. The ticketing system of claim 1, the ticketing processor subsystem further configured to:
search a knowledge database by using a knowledge matching algorithm to identify a match between the problem and the associated problem information of the problem ticket and one or more matching knowledge articles for resolution of the problem of the problem ticket; and
add the one or more matching knowledge articles for resolution of the problem to the problem ticket and the learned problem profile, prior to the assignment of one of the analysts of the rank ordered learned analyst profiles to the problem ticket,
wherein the one or more matching knowledge articles include instructions for resolution of a completed problem ticket.

5. The ticketing system of claim 1, ticketing processor subsystem further configured to:
create a problem ticket reference number for the problem ticket;
add the problem ticket reference number to the problem ticket; and
send the problem ticket reference number to the client information handling system.

6. The ticketing system of claim 1, the client information handling system further comprising a client processor subsystem configured to:
detect an occurrence of the problem during execution of an application by the client processor subsystem; and
in response to the occurrence of the problem and a user request from a user interface, execute a ticket submission module to:
collect the problem information associated with the occurrence of the problem;
create the problem ticket including the problem information;
send the problem ticket to the ticketing information handling system;
receive a problem ticket reference number associated with the problem ticket from the ticketing information handling system; and
provide the problem ticket reference number to the user interface for user notification.

7. The ticketing system of claim 1, wherein the categorization algorithm is an anytime optimal search-based algorithm.

8. The ticketing system of claim 1, wherein the problem information comprises one or more of:
an error message;
an error code;
an exception code;
a screenshot of information displayed by a user interface on a display of the client information handling system;
a page name and a page header of the information displayed by the user interface on the display;
a transaction name;
a product name;
a business process name;
a business domain name;
a problem severity;
a submission time;
a selected problem priority;
an accepted problem priority;
an adjusted service level agreement (SLA);
an accepted SLA; and
analyst email associated with the problem of the problem ticket associated with the problem information.

9. The ticketing system of claim 1, wherein the performance metrics comprise one or more of:
a customer satisfaction score;
a service level agreement metric; and
a reoccurrence metric.

10. The ticketing system of claim 1, wherein the analyst information comprises one or more of:
a business domain;
shift information;
a time zone;
a holiday zone;
a start date;
a current work load; and
a next available time; and
wherein the user information comprises one or more of:
a business domain;
shift information;
a time zone;
a holiday zone;
contact information;
analyst preferences;
a next available time; and
a SLA associated with a user.

11. A method, comprising:
receiving, by a ticketing processor subsystem of a ticketing information handling system of a ticketing system, a problem ticket including a problem and associated problem information from a client information handling system of the ticketing system;
categorizing, by the ticketing processor subsystem, the problem of the problem ticket into a problem category of a learned problem profile of a learned problem profile database by using a categorization algorithm to identify a match between the problem and the associated problem information and learned problems and associated learned problem information of the learned problem profile;
performing, by the ticketing processor subsystem, a rank ordering algorithm to order learned analyst profiles of a learned analyst profile database based on performance metrics associated with the learned problem profile and a respective analyst of each of the learned analyst profiles, wherein the respective analyst of each of the learned analyst profiles has resolved one or more of the learned problems associated with the learned problem profile; and
assigning, by the ticketing processor subsystem, one of the analysts of the rank ordered learned analyst profiles to the problem ticket by using an assignment algorithm based on analyst information associated with the respective analyst of each of the rank ordered learned analyst profiles.

12. The method of claim 11, further comprising:
adding the problem ticket to the learned problem profile, when the categorization algorithm identifies the match between the problem and the associated problem information and the learned problems and the associated learned problem information; and
adding the problem ticket including the problem and the associated problem information to a new learned problem profile having a new problem category to the learned problem profile database, when the categorization algorithm is unable to identify the match.

13. The method of claim 11, further comprising:
for each of one or more completed problem tickets in an operational database:
retrieving an assigned analyst, analyst information associated with the assigned analyst, a known learned problem profile in the learned problem profile database associated with the completed problem ticket, and performance metrics associated with the assigned analyst and the completed problem ticket from an operational database; and
adding the analyst information and the performance metrics to a learned analyst profile in the learned analyst profile database associated with the assigned analyst.

14. The method of claim 11, further comprising:
searching a knowledge database by using a knowledge matching algorithm to identify a match between the problem and the associated problem information of the problem ticket and one or more matching knowledge articles for resolution of the problem of the problem ticket; and
adding the one or more matching knowledge articles for resolution of the problem to the problem ticket and the learned problem profile, prior to the assignment of one of the analysts of the rank ordered learned analyst profiles to the problem ticket,
wherein the one or more matching knowledge articles include instructions for resolution of a completed problem ticket.

15. The method of claim 11, further comprising:
creating a problem ticket reference number for the problem ticket;
adding the problem ticket reference number to the problem ticket; and
sending the problem ticket reference number to the client information handling system.

16. The method of claim 11, further comprising:
detecting, by a client processor subsystem of the client information handling system, an occurrence of the problem during execution of an application by the client processor subsystem; and
in response to the occurrence of the problem and a user request from a user interface:
collecting the problem information associated with the occurrence of the problem;
creating the problem ticket including the problem information;
sending the problem ticket to the ticketing information handling system;
receiving a problem ticket reference number associated with the problem ticket from the ticketing information handling system; and
providing the problem ticket reference number to the user interface for user notification.

17. The method of claim 11, wherein the categorization algorithm is an anytime optimal search-based algorithm.

18. The method of claim 11, wherein the problem information comprises one or more of:
an error message;
an error code;
an exception code;
a screenshot of information displayed by a user interface on a display of the client information handling system;
a page name and a page header of the information displayed by the user interface on the display;
a transaction name;
a product name;
a business process name;
a business domain name;
a problem severity;
a submission time;
a selected problem priority;
an accepted problem priority;
an adjusted service level agreement (SLA);
an accepted SLA; and
analyst email associated with the problem of the problem ticket associated with the problem information.

19. The method of claim 11, wherein the performance metrics comprise one or more of:
a customer satisfaction score;
a service level agreement metric; and
a reoccurrence metric.

20. The method of claim 11, wherein the analyst information comprises one or more of:
a business domain;
shift information;
a time zone;
a holiday zone;
a start date;
a current work load; and
a next available time; and
wherein the user information comprises one or more of:
a business domain;
shift information;
a time zone;
a holiday zone;
contact information;
analyst preferences;
a next available time; and
a SLA associated with a user.
